(19) United States
(12) Patent Application Publication
(10) Pub. No.: US 2011/0148601 A1
(43) Pub. Date: Jun. 23, 2011

(54) RADIO FREQUENCY IDENTIFICATION (RFID) DEVICE

(75) Inventor: Hee Bok KANG, Cheongju (KR)

(73) Assignee: Hynix Semiconductor Inc., Icheon (KR)

(21) Appl. No.: 12/755,267

(22) Filed: Apr. 6, 2010

(30) Foreign Application Priority Data
Dec. 23, 2009 (KR) 10-2009-0129391

(51) Int. Cl. H04Q 5/22

(52) U.S. Cl. 340/10.34; 340/10.51

(57) ABSTRACT

A radio frequency identification (RFID) device is disclosed. The RFID device is configured to read/write data in response to a radio frequency (RF) signal received from an antenna unit. The RFID device includes an event controller, a connection unit, and a driving controller. The event controller outputs a control signal for executing a specific event, if a command signal generated by the RF signal corresponds to predetermined specific event data. The connection unit is connected to an external driving device of the RFID device. The driving controller outputs a driving signal controlling an operation of the driving device to the connection unit in response to the control signal.

### CROSS-REFERENCE TO RELATED APPLICATION

The priority of Korean patent application No. 10-2009-0129391 filed on Dec. 23, 2009, the disclosure of which is hereby incorporated in its entirety by reference, is claimed.

### BACKGROUND OF THE INVENTION

Embodiments of the present invention relate to a radio frequency identification (RFID) device, and more specifically, to a technology for automatically identifying an object by wirelessly transmitting and receiving a radio frequency (RF) signal to and from an external reader via an antenna.

A radio frequency identification (RFID) tag chip has been widely used to automatically identify objects using a radio frequency (RF) signal. In order to automatically identify an object using the RFID tag chip, an RFID tag is first attached to the object to be identified, and an RFID reader wirelessly communicates with the RFID tag of the object in such a manner that a non-contact automatic identification scheme can be implemented. With the widespread use of such RFID technologies, shortcomings of related automatic identification technologies, such as barcode and optical character recognition technologies, can be greatly reduced.

In recent times, the RFID tag has been widely used in physical distribution management systems, user authentication systems, electronic money (e-money), transportation systems, and the like.

For example, the physical distribution management system generally performs a classification of goods or management of goods in stock using an Integrated Circuit (IC) recording data therein, instead of using a delivery note or tag. In addition, the user authentication system generally performs an Entrance and Exit Management function using an IC card including personal information or the like.

In the meantime, a non-volatile ferroelectric memory may be used as a memory in an RFID tag. Generally, a non-volatile ferroelectric memory, [e.g., a ferroelectric Random Access Memory (FeRAM)] has a data processing speed similar to that of a Dynamic Random Access Memory (DRAM). The non-volatile ferroelectric memory also preserves data even when power is turned off. Because of these properties many developers are conducting intensive research into FeRAM as a next generation memory device.

The above-mentioned FeRAM has a very similar structure to that of DRAM, and uses a ferroelectric capacitor as a memory device. The ferroelectric substance has high residual polarization characteristics, such that data is not deleted although an electric field is removed.

FIG. 1 is a block diagram illustrating a general RFID device. The RFID device according to the related art generally includes an antenna unit 1, an analog unit 10, a digital unit 20, and a memory unit 30.

In this case, the antenna unit 1 receives a radio frequency (RF) signal from an external RFID reader. The RF signal from the antenna unit 1 is input to the analog unit 10 via antenna pads 11 and 12.

The analog unit 10 amplifies the input RF signal, such that it generates a power-supply voltage VDD indicating a driving voltage of an RFID tag. The analog unit 10 detects an operation command signal from the input RF signal, and outputs a command signal CMD to the digital unit 20. In addition, the analog unit 10 detects the output voltage VDD, such that it outputs not only a power-on reset signal POR controlling a reset operation but also a clock CLK to the digital unit 20.

The digital unit 20 receives the power-supply voltage VDD, the power-on reset signal POR, the clock CLK, and the command signal CMD from the analog unit 10, and outputs a response signal RP in response to the received signals to the analog unit 10. The digital unit 20 outputs an address ADD, Input/Output data (I/O), a control signal CTR, and a clock CLK to the memory unit 30.

The memory unit 30 reads and writes data using a memory device, and stores data therein.

In this case, the RFID device uses frequencies of various bands. In general, as the value of a frequency band is lowered, the RFID device has a slower recognition speed, has a shorter operating distance, and is less affected by environments (e.g., disruption form WiFi, cellphones, etc.) In contrast, as the value of a frequency band is increased, the RFID device has a faster recognition speed, has a greater operating distance, and is considerably affected by peripheral environments.

### BRIEF SUMMARY OF THE INVENTION

Various embodiments of the present invention are directed to providing a radio frequency identification (RFID) device that substantially obviates one or more problems due to limitations and disadvantages of the related art.

An embodiment of the present invention relates to an RFID device in which a specific event operation status is pre-stored in the RFID device so that a control area for use in the RFID device is established.

An embodiment of the present invention relates to an RFID device in which a specific event operation status is pre-stored in the RFID device, and a control area of the RFID device is established, so that a security problem is solved and the reliability of the RFID device is increased.

In accordance with an embodiment of the present invention, a radio frequency identification (RFID) device is configured to read/write data in response to a radio frequency (RF) signal received from an antenna unit. The RFID device includes an event controller configured to output a control signal for executing a specific event, if a command signal generated by the RF signal corresponds to predetermined specific event data; a connection unit configured to be connected to an external driving device of the RFID device; and a driving controller configured to output a driving signal controlling an operation of the driving device to the connection unit in response to the control signal.

As described above, the RFID device according to the embodiment of the present invention has the following effects.

The RFID device pre-stores a specific event operation status in the RFID chip so as to establish an RFID control area, so that the security and reliability of the RFID device are increased.

It is to be understood that both the foregoing general description and the following detailed description of the present invention are exemplary and explanatory and are intended to provide further explanation of the invention as claimed.

It will be appreciated by persons skilled in the art that that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

FIG. 1 is a block diagram illustrating a conventional RFID device according to a related art.

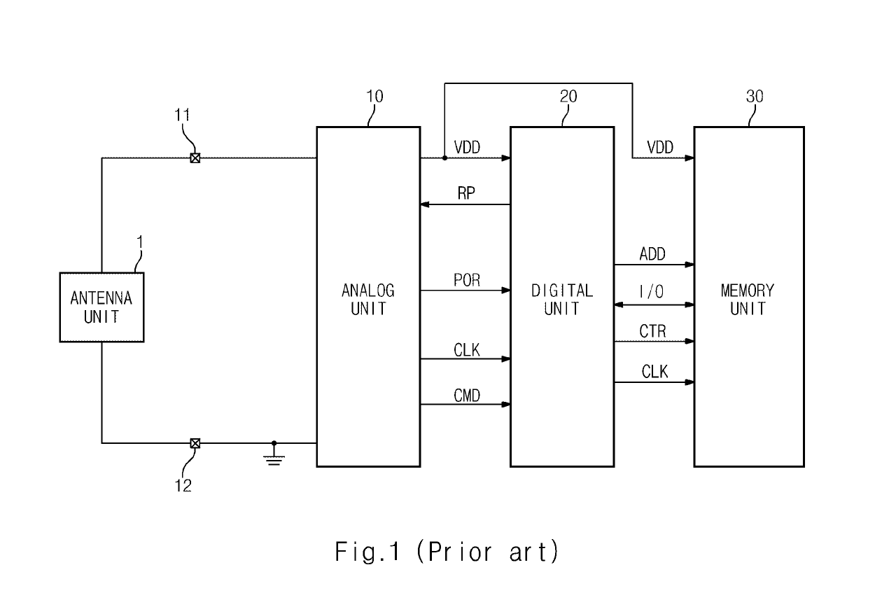

FIG. 2 is a circuit diagram illustrating an RFID device according to an embodiment of the present invention.

FIG. 3 is a detailed block diagram illustrating an event controller shown in FIG. 2.

FIG. 4 is a flowchart illustrating operations of an event controller shown in FIG. 2.

### DESCRIPTION OF EMBODIMENTS

Reference will now be made in detail to the embodiments of the present invention, examples of which are illustrated in the accompanying drawings. Wherever possible, the same reference numbers will be used throughout the drawings to refer to the same or like parts.

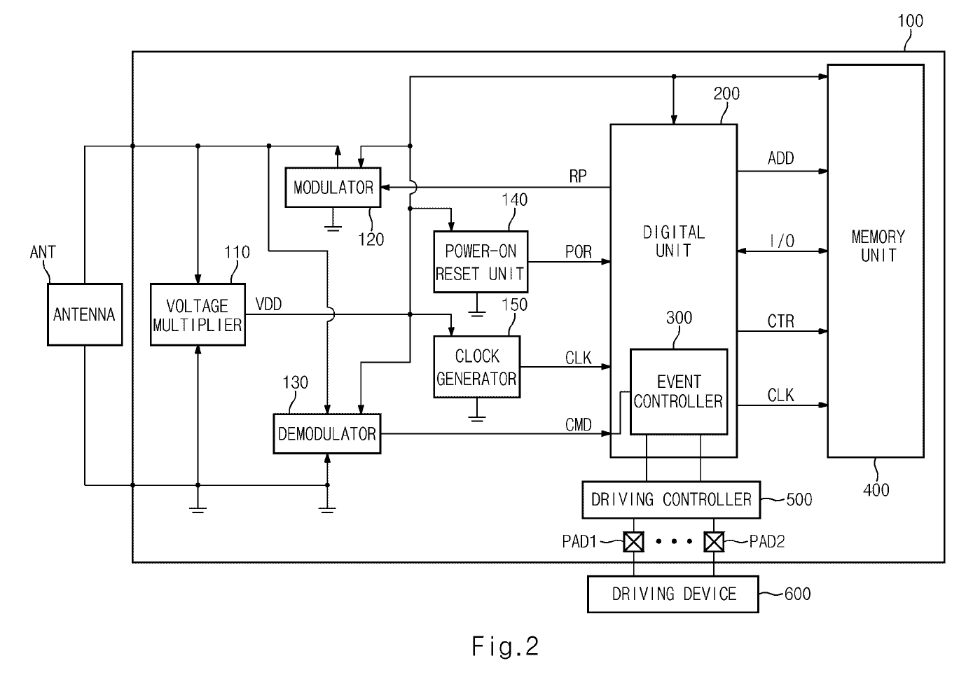

FIG. 2 is a circuit diagram illustrating an RFID device according to an embodiment of the present invention. Referring to FIG. 2, the RFID device 100 includes an antenna ANT, a voltage multiplier 110, a modulator 120, a demodulator 130, a power-on reset unit 140, a clock generator 150, a digital unit 200, a memory unit 400, a driving controller 500, and pads PAD1 and PAD2. The digital unit 200 also includes an event data controller 300.

In this case, the antenna ANT receives a radio frequency (RF) signal from an RFID reader. The RF signal received in the RFID device is input to the RFID chip via antenna pads. The voltage multiplier 110 rectifies and boosts the RF signal received via the antenna ANT, and generates a power-supply voltage serving as an RFID-device driving voltage.

The modulator 120 modulates a response signal RP received from the digital unit 200, and outputs the modulated response signal RP to the antenna ANT. The demodulator 130 demodulates the RF signal received from the antenna ANT in response to the output voltage of the voltage multiplier 110, and outputs a command signal CMD to the digital unit 200.

The power-on reset unit 140 detects a power-supply voltage generated in the voltage multiplier 110, and outputs a power-on reset signal POR to the digital unit 200 so as to control a reset operation in response to the detected power-supply voltage. In this case, a detailed example of the power-on reset signal POR are as follows. While the power-on reset signal POR increases simultaneously with a power-supply voltage during a transition time in which the power-supply voltage changes from a low level to a high level, as soon as a power source reaches the power-supply voltage VDD, the power-on reset signal POR is changed from a high level to a low level, such that it is able to reset a circuit included in the RFID device.

The clock generator 150 outputs a clock signal CLK to the digital unit 200, wherein the clock signal CLK is capable of controlling operations of the digital unit 200 in response to the power-supply voltage VDD generated from the voltage multiplier 110.

The digital unit 200 receives a power-supply voltage VDD, a power-on reset signal POR, a clock signal CLK, and a command signal CMD (which is analyzed in the event controller 300), and generates a control signal and process signals. The digital unit 200 outputs a response signal RP corresponding to the control and process signals to the modulator 120. The digital unit 200 also outputs an address ADD, input/output data I/O, a control signal CTR, and a clock signal CLK to the memory unit 400.

The event controller 300 receives the command signal CMD from the demodulator 130 and determines whether or not an actionable event has occurred from the event data. The event controller 300 pre-establishes an operation status of the event data (i.e., establish a reference point to measure or count from to determine if an event has occurred).

The event controller 300 pre-establishes various event data so as to monitor the number of memory read operations of a specific address, the number of memory write operations of a specific address, the number of operations of a specific command, and the number of password access operations.

Therefore, the embodiment of the present invention pre-establishes a specific event operation status in the event controller 300 so as to control a driving device when the desired operation status of the RFID device is reached. As a result, the embodiment of the present invention can help verify an RFID control area (i.e., the RFID's range), help with security problems (e.g., alert someone if a tagged item is taken into a restricted area or turn on lights when an authorized person enters an area), and provide a simple feedback or control system without the need to manually operate a RFID tag reader.

The memory unit 400 includes a plurality of memory cells. Each memory cell writes data in a storage unit, and reads the data therefrom.

In this case, the memory unit 400 may be a non-volatile ferroelectric memory (FeRAM). The FeRAM has a data processing speed similar to that of a DRAM. Also, the FeRAM has a structure very similar to that of DRAM, and uses a ferroelectric substance as a capacitor material so that it has high residual polarization characteristics. Due to the high residual polarization characteristics, data is not deleted although an electric field is removed.

The driving controller 500 is connected to the event controller 300. In response to the control signal received from the event controller 300, the driving controller 500 outputs a driving signal for controlling operations of the external driving device 600 to the pads PAD1 and PAD2. The driving device 600 is connected to the driving controller 500 of the RFID device through the pads PAD1 and PAD2.

In this case, each of the pads PAD1 and PAD2 is connected to the external driving device 500 through a connection pin, and corresponds to a connection unit for connecting the RFID device 100 to the driving device 600. The driving device 600 may be a light emitting diode (LED), a motor, a speaker, and the like.

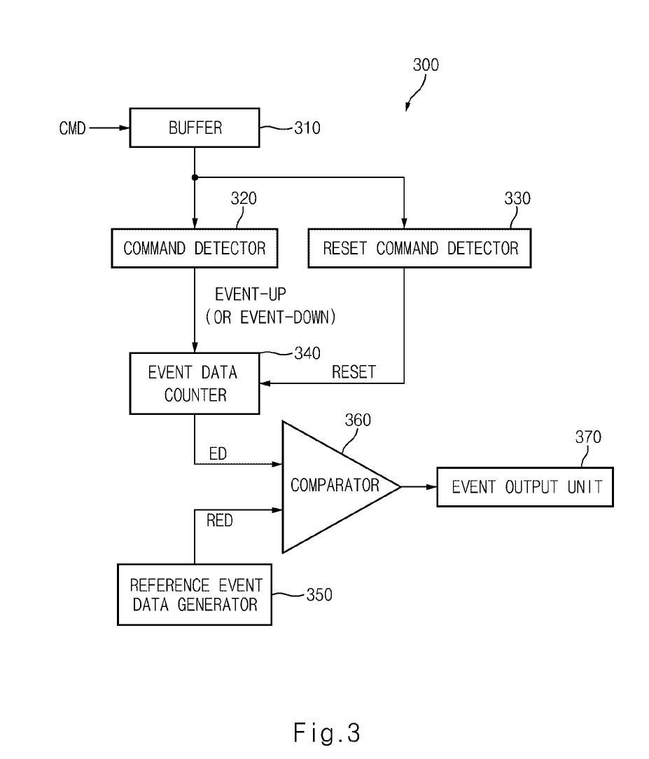

FIG. 3 is a detailed block diagram illustrating an event controller shown in FIG. 2. Referring to FIG. 3, the event controller 300 includes a buffer 310, a command detector 320, a reset command detector 330, an event data counter 340, a reference event data generator 350, a comparator 360, and an event output unit 370.

In this case, the buffer 310 buffers a command signal CMD received from the demodulator 130, and outputs the buffered command signal CMD. The command detector 320 determines whether the signal received from the buffer 310 is a specific event command. The command detector 320 outputs an event-up signal or an event-down signal when the signal received from the buffer 310 is associated with the event command.

In addition, the reset command detector 330 determines whether the signal received from the buffer 310 is a reset command. The reset command detector 330 outputs a reset signal RESET when the signal received from the buffer 320 is associated with the reset command.

The event data counter 340 counts event data in response to the event-up signal or event-down signal received from the command detector 320, and therefore outputs the resultant event data ED.

The event data counter 340 resets a counted value in response to the reset signal RESET received from the reset command detector 330.

The reference event data generator 350 generates an objective reference event data RED. A value of a user-desired event data is pre-established in the reference event data generator 350. In this case, event data in the reference event data generator 350 may be set from RF signals received from the antenna ANT.

The comparator 360 compares event data ED received from the event data counter 340 with reference event data RED received from the reference event data generator 350, and outputs the result of comparison between the event data ED and the reference event data RED. The event controller (also called ‘event execution controller’) 370 outputs a control signal for controlling operations related to event execution in response to an output signal of the comparator 360.

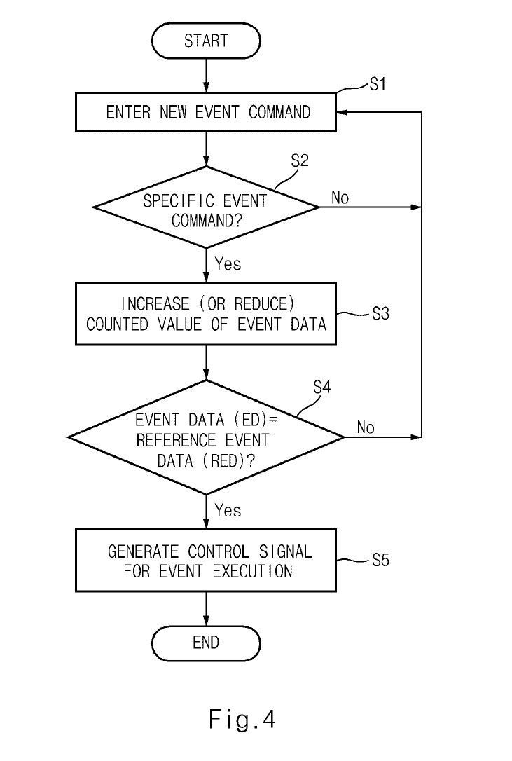

FIG. 4 is a flowchart illustrating the event controller 300 shown in FIG. 2. Referring to FIG. 4, an external reader transmits an RF signal to the antenna ANT. The demodulator 130 detects a command signal CMD from the RF signal received from the antenna ANT, and outputs the detected command signal CMD to the event controller 300.

The buffer 310 buffers the command signal CMD received from the demodulator 130, and outputs the buffered command signal CMD. A new event command is input to the command detector 320 of the event controller 300 at step S1. The command detector 320 determines whether the event command received from the buffer 310 is a predetermined specific event command at step S2.

The command detector 320 outputs an event-up signal or event-down signal if the signal received from the buffer 310 is associated with a specific event command. In contrast, if the signal received from the buffer 310 does not correspond to a specific event command, the command detector 320 does not output an event signal and waits for a new event command signal.

The event data counter 340 counts event data in response to the event-up signal or event-down signal received from the command detector 320, and thus increases or reduces a counted value of the event data ED at step S3. In this case, the event data counter 340 counts the event-up signal or event-down signal received from the command detector 320, and accumulates the counted results.

In other words, upon receiving the event-up signal from the command detector 320, the event data counter 340 increases a counted value of event data ED by one. In contrast, the event data counter 340 reduces a counted value of event data ED by one upon receiving the event-down signal from the command detector 320.

In this case, the event command received from the buffer 310 is also input to the reset command detector 330. If the event command is a specific event command, the command detector 320 is operated. If the event command is a reset command, the reset command detector 330 is operated. If the reset command detector 330 is operated, the counted value accumulated in the event data counter 340 is reset in response to the reset signal RESET.

The buffer 310, the command detector 320, and the event data counter 340 repeatedly count specific event commands until the event data ED is identical to reference event data RED received from the reference event data generator 350.

Thereafter, the comparator 360 compares event data ED received from the event data counter 340 with reference event data RED generated from the reference event data generator 350, and outputs the result of comparison between the event data ED and the reference event data RED at step S4.

If the event data ED accumulated in the event data counter 340 is identical to reference event data RED (or also referred to as “reference event”), an output signal of the comparator 360 is activated. In the present embodiment the reference event data are predetermined but they may be generated in real time in other embodiments. In contrast, if the accumulated event data ED does not have the same value as that of the reference event data RED, the comparator 360 again receives a new event command signal.

Subsequently, the event output unit 370 generates a control signal for executing an event through the event output unit 370 at step S5. As a result, the driving device 600 is operated through the driving controller 500, such that the operation corresponding to specific event data ED is carried out.

As an example, the event data ED equaling the reference event data RED may correspond to the number of operation times of the driving device 600. In addition, the event data ED may correspond to an event condition. For example, if event data with a specific pattern is input to the event controller 300, the event controller 300 allows the driving device 600 to be operated. In addition, if the number of data write operations in the memory unit 400 is equal to or higher than a specific number of times, the event controller 300 may control the memory unit 400 not to write data therein.

In recent times, an illumination lamp installed in a building or the like may generally include a plurality of LED elements. In this case, several LED elements are respectively turned on or off so that the on/off control result appears as a special pattern of lights. In addition, each illumination lamp may be controlled to have a user-desired brightness, or a certain illumination lamp arranged at a user-desired position may be separately controlled.

The above-mentioned scheme for controlling the illumination lamp may control the illumination lamp at a distance through the RFID device. In other words, in the case where an RFID tag is attached to each LED and a desired RF signal is transmitted to each RFID tag through an external reader, the RFID tag attached to the LED recognizes the transmitted RF signal and receives additional data according to a unique ID, so that the above-mentioned scheme can can control the user-desired number of LEDs to have a user-desired brightness.

The embodiment of the present invention may establish specific event data in the event controller 300 of the RFID device. For example, if the driving device 600 corresponds to an LED, the number of turn-ON operations of the LED may be limited to a predetermined number of times. If the operation voltage of the LED is equal to or less than a predetermined voltage, the embodiment of the present invention may control the LED to not be switched off.

In addition, a password may be pre-established in the event controller 300. If a password signal having been entered as new event data is not identical to a predetermined password, the embodiment of the present invention may control the LED to not be switched on. In this case, the embodiment of the present invention allows an illumination system such as a building to be controlled only by an administrator or manager who has recognized a correct password, so that the flexibility of the illumination system can be increased.

In addition, the embodiment of the present invention may pre-establish an LED operation time in the event controller 300, so that it may control each LED to be switched on only during a defined time period. Also, information about continuous use time of the LEDs is established in the event controller 300, so that the embodiment of the present invention may also control the LED device to be driven only for a user defined time.

Although the above-mentioned embodiments of the present invention have been disclosed by limiting the driving device 600 to one or more LEDs, the scope or spirit of the present invention is not limited only thereto. If necessary, the driving device 600 may further include a light Emitting diode (LED), a motor, a speaker, and the like.

In recent times, an illumination lamp installed in a building or the like may generally include a plurality of LED elements. In this case, several LED elements are turned on or off so that the on/off control result appears as a special pattern of lights. In addition, each illumination lamp may be controlled to have a user-desired brightness, or a certain illumination lamp arranged at a user-desired position may be separately controlled.

The above-mentioned scheme for controlling the illumination lamp may control the illumination lamp at a distance through the RFID device. In other words, in the case where an RFID tag is attached to each LED and a desired radio frequency (RF) signal is transmitted to each RFID tag through an external reader, the RFID tag attached to the LED recognizes the transmitted RF signal and receives additional information according to a unique ID, so that the above-mentioned scheme can adjust a user-desired number of LEDs and can control the user-desired number of LEDs to have a user-desired brightness.

The RFID tag is relatively cheaper than a general wireless remote controller. Accordingly, if the RFID tag is applied to the illumination lamp, the implementation cost can be decreased.

Although a number of illustrative embodiments consistent with the invention have been described, it should be understood that numerous other modifications and embodiments can be devised by those skilled in the art that will fall within the spirit and scope of the principles of this disclosure. Particularly, numerous variations and modifications are possible in the component parts and/or arrangements which are within the scope of the disclosure, the drawings and the accompanying claims. In addition to variations and modifications in the component parts and/or arrangements, alternative uses will also be apparent to those skilled in the art.

What is claimed is:

1. A radio frequency identification (RFID) device configured to read/write data in response to a radio frequency (RF) signal received from an antenna unit, the RFID device comprising:
an event controller configured to receive a command signal generated according to the RF signal and output a control signal if the command signal corresponds to a reference event provided to the event controller;
a connection unit configured to be coupled to an external driving device of the RFID device; and
a driving controller configured to output a driving signal for controlling an operation of the driving device to the connection unit in response to the control signal.

2. The radio frequency identification (RFID) device according to claim 1, wherein the event controller includes one or more reference events that are predefined, the reference events including one or more of the following events: a number of memory read operations of a specific address, a number of memory write operations of a specific address, a number of operations of a specific command, and a number of password access operations.

3. The radio frequency identification (RFID) device according to claim 1, wherein the event controller includes:
a. buffer configured to receive the command signal and output a signal;
a command detector configured to extract specific event data from the output signal of the buffer;
an event data counter configured to count according to a value of the specific event data and output count data;
a comparator configured to compare the count data of the event data counter with a predefined reference value that corresponds to the reference event; and
an event output unit configured to output the control signal in response to an output result of the comparator, the control signal being used to execute a specific event.

4. The radio frequency identification (RFID) device according to claim 3, wherein the event controller further includes a reference event data generator configured to generate the predefined reference value.

5. The radio frequency identification (RFID) device according to claim 3, wherein the event controller further includes a reset command detector configured to output a reset signal if a reset command is detected from the output signal of the buffer.

6. The radio frequency identification (RFID) device according to claim 5, wherein the event data counter resets an accumulated count value in response to the reset signal.

7. The radio frequency identification (RFID) device according to claim 3, wherein the command detector outputs an event-up or event-down signal when the signal output by the buffer is associated with an event command.

8. The radio frequency identification (RFID) device according to claim 3, wherein the command detector receives a new event command signal as an input when the command signal does not correspond to the specific event data.

9. The radio frequency identification (RFID) device according to claim 3, wherein the comparator outputs an activated output signal when output data of the event data counter corresponds to the reference value, and receives a new event command signal as an input when output data of the event data counter is different from the reference value.

10. The radio frequency identification (RFID) device according to claim 1, wherein the connection unit includes a pad connected between the driving device and the driving controller.

11. The radio frequency identification (RFID) device according to claim 1, further comprising:
a voltage multiplier configured to generate a power-supply voltage of the RFID device;
a demodulator configured to generate the command signal by demodulating the RF signal;
a digital unit configured to generate process signals in response to the command signal;
a memory unit configured to read/write data in response to the process signals; and
a modulator configured to modulate a response signal received from the digital unit.

12. The radio frequency identification (RFID) device according to claim 11, wherein the event controller is included in the digital unit.

13. The radio frequency identification (RFID) device according to claim 11, further comprising:
a power-on reset unit configured to output a power-on reset signal to the digital unit in response to the power-supply voltage; and
a clock generator configured to generate a clock signal in response to the power-supply voltage, and output the generated clock signal to the digital unit.

14. The radio frequency identification (RFID) device according to claim 11, wherein the memory unit includes a non-volatile ferroelectric memory.

15. The radio frequency identification (RFID) device according to claim 1, wherein the driving device is adapted to control a light emitting diode (LED).

16. The radio frequency identification (RFID) device according to claim 1, wherein the driving device is adapted to control a motor.

17. The radio frequency identification (RFID) device according to claim 1, wherein the driving device is adapted to control a speaker.

18. The radio frequency identification (RFID) device according to claim 1, wherein the specific event data is predefined in a reference value generator in response to the RF signal.
